(19) United States
(12) Patent Application Publication
(10) Pub. No.: US 2015/0248522 A1
(43) Pub. Date: Sep. 3, 2015

(54) Method and System for Identification of Disease Causing Variants

(71) Applicant: The Board of Trustees of the Leland Stanford Junior, University, Palo Alto, CA (US)

(72) Inventors: Harendra Guturu, San Francisco, CA (US); Gil Bejerano, Stanford, CA (US)

(21) Appl. No.: 14/634,809

(22) Filed: Feb. 28, 2015

Related U.S. Application Data
(60) Provisional application No. 61/945,829, filed on Feb. 28, 2014.

(51) Int. Cl. G06F 19/18

(52) U.S. Cl. CPC G06F 19/18

(57) ABSTRACT

Embodiments of the present invention include methods for discovering deleterious human variants for a given human whole genome sequence or genotype and predicting the functional consequence of the variants.

### CROSS-REFERENCE TO RELATED APPLICATIONS

This application claims priority to U.S. Provisional Application No. 61/945,829 filed Feb. 28, 2014, which is hereby incorporated by reference in its entirety for all purposes.

### FIELD OF THE INVENTION

The present invention generally relates to the genetic analysis.

### BACKGROUND OF THE INVENTION

The advent of high-throughput genotyping spurred the rise of genome-wide association studies (GWAS) aimed at identifying the basis of genetic diseases. GWAS and the growing body of non-coding genome annotations have helped improve understanding of the genetic basis of diseases by shifting the focus from protein coding and copy number variations and genome rearrangements to the non-coding genome by suggesting a gene regulatory component to human health and disease susceptibility. But, one development of GWAS is the “missing heritability problem”, which observes that loci detected by GWAS in general only explain a small fraction of the genetic variance responsible for phenotype.

Some suggested models of genetic variance responsible for the “missing heritability problem” include “the infinitesimal model”—a large number of small effect common variants and “the rare allele model”—a large number of large-effect rare variants. There also exist suggestions that such missing heritability can be explained due to epistatic interactions between variants rather than independent polymorphisms.

### SUMMARY OF THE INVENTION

Although many human diseases have a genetic component involving many loci, the majority of studies are statistically underpowered to isolate the many contributing loci, raising the question of the existence of an alternate process to identify disease variants. To address this question in an embodiment of the present invention, ancestral binding sites of regulatory factors disrupted by an individual's variants are collected. Then, a search is performed for their most significant congregation next to a group of functionally related genes. Strikingly, when the method is applied to five different full human genomes, the top enriched function for each is invariably reflective of their very different medical histories.

Results of an embodiment of the present invention suggest that erosion of gene regulation results in function specific mutation loads that manifest as familial medical history. An embodiment of the present invention, includes a test that exposes a hitherto hidden layer of loci that promises to shed new light on human disease penetrance, expressivity and severity and the sensitivity with which they can be detected.

A purpose of an embodiment of the present invention is to discover deleterious human variants for a given human whole genome sequence or genotype and predict the functional consequence of the variants.

In an embodiment of the present invention, genomic variants for a sequenced or genotyped individual are intersected with high quality conserved transcription factor binding sites. The ancestral variant is identified based on agreement of the reference genome, the sequenced individual and the chimp genome. If the conserved transcription factor binding site shows a greater than 5% decrease in information match in the sequenced genome compared to the ancestral variant, the variant is marked deleterious.

The set of all deleterious variants for a given individual are identified and then using genomic region enrichment analysis the most statistically significant function is identified in an embodiment of the present invention. This function is hypothesized to be the major disease phenotype of the individual.

Applications of the present invention include: 1) development of disease diagnostics and prediction assays using genetic markers identified by the method; and 2) discovering individual specific disease variants.

An advantage of the methods of an embodiments of the present invention are the ability to detect deleterious variants specific for a particular individual and then prediction of functional consequence in a disease agnostic fashion. This methods can be applied to multiple genome with a particular disease and the common reoccurring variants can be compiled into a detection assay for a particular disease. These methods shows proof of concept of combining personal genomic data with a published and highly used (350 jobs/day) genomic enrichment method to detect disease potential due to variant interaction.

An embodiment of the present invention is directed to whole genome sequences. An alternative embodiment is directed at SNP chips. In an alternative embodiment, variants can be called with respect to a reference genome defined by ethnicity rather than the common human reference. In another embodiment, the Neanderthal or Denisova genomes can be used to define ancestral states rather than chimp.

Advantageous aspects of embodiments of the present invention include: 1) identification of functional variants per individual without requiring large patient cohorts for statistical significance; 2) detection of groups of common variants that are cumulatively responsible for particular diseases or disorders; 3) ability to characterize potentially interacting pairs of variants that confer disease load; and 4) no dependence on previously identified putative disease variants that may have population specific effects.

Currently, to identify potential functional variants, large cohorts of individuals need to be sequenced and compared to achieve statistical significance. Furthermore, this current method is very expensive and yields few variants that have weak functional effect.

Methods according to embodiments of the present invention drastically reduce the cost of identifying functional variants by focusing on individual genomes and violations of conservation to side step the need to perform many statistical tests. Additionally, these methods are disease agnostic and interprets the genome lending themselves for detection of disease causes for many rare disorders that may be impossible to characterize using traditional statistical methods.

These and other embodiments and advantages can be more fully appreciated upon an understanding of the detailed description of the invention as disclosed below in conjunction with the attached Figures.

### BRIEF DESCRIPTION OF THE DRAWINGS

The following drawings will be used to more fully describe embodiments of the present invention.

FIG. 1A: Shown is a block diagram for a method for inferring conserved binding site eroding loci (CoBELs) and hypothesizing functional consequences of erosions.

FIG. 1B: Shown are conserved binding site eroding loci (CoBELs) that are human reference transcription factor binding sites conserved across multiple mammals, that are disrupted by a sequenced individual's derived variant. Shown is a CoBEL upstream of ADRA1B contributing to the Quake genome “abnormal cardiac output” prediction in Table 1 (FIG. 4).

FIG. 1C: Shown are conserved binding site eroding loci (CoBELs) that are checked for enrichment of function and the functional phenotypes are matched to medical histories via literature survey. Each step is evaluated for statistical significance in an embodiment of the present invention.

FIG. 1D: Shown is a block diagram of an alternative embodiment of the present invention that highlights a general algorithm.

FIG. 2.A-E: Shown are comparisons of individual specific enrichment's statistics compared to 1094 genomes from the 1000 genomes project and the 5 genomes analyzed in this report. Dashed lines indicate GREAT's default binomial fold (>=2) and FDR (<=0.05) significance thresholds. Lower right corner has mass of genomes that were not significant by GREAT's default hypergeometric FDR (<=0.05).

FIG. 3A: Shown are principal component analysis (PCA) of the five genomes with respect to the genomes in the 1000 genomes project, revealed clustering with the European population as expected.

FIG. 3B-F: Shown are comparisons of individual's enrichment specific CoBEL frequencies in the whole 1000 genomes and the two most similar populations by PCA.

FIG. 4 (Table 1): Shown are top predicted phenotype and matching medical phenotype: The set of conserved binding site eroding loci (CoBELs) for each individual is searched for the most significant congregation of binding site erosion events next to a group of genes sharing the same function or phenotype. Per personal genome, the top row columns 2-7 describe the obtained top prediction from personal genome data, and column 8 highlights the matching personal medical phenotype. The bottom row per entry provides exact quotes from references that confirm the link between the predicted and observed phenotypes (columns 2 and 8).

FIG. 5: Shown is a block diagram of a computer system on which the present invention can be implemented.

FIG. 6: Shown is the number and distribution of CoBEL (conserved binding site eroding loci) SNPs for the Table 1 (FIG. 4) enrichments across the five personal genomes. Individual variants, colored red, make the largest contribution (17%-34%) across all five enrichments.

FIG. 7 (Table S1): Shown is a table of GREAT enrichments for GWAS SNPs are congruent with GWAS phenotype.

FIG. 8 (Table S2): Shown is a table of False Discovery Rate (FDR) of enrichments using 1000 Genomes Data.

FIG. 9 (Table S3): Shown is a table of narcolepsy associated SNPs.

### DETAILED DESCRIPTION OF THE INVENTION

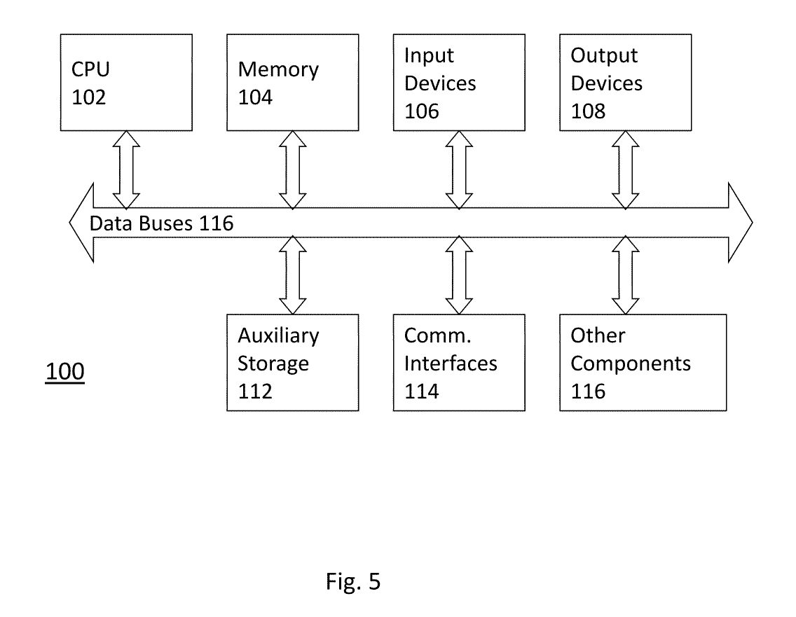

Among other things, the present invention relates to methods, techniques, and algorithms that are intended to be implemented in a digital computer system 100 such as generally shown in FIG. 5. Such a digital computer is well-known in the art and may include the following.

Computer system 100 may include at least one central processing unit 102 but may include many processors or processing cores. Computer system 100 may further include memory 104 in different forms such as RAM, ROM, hard disk, optical drives, and removable drives that may further include drive controllers and other hardware. Auxiliary storage 112 may also be include that can be similar to memory 104 but may be more remotely incorporated such as in a distributed computer system with distributed memory capabilities.

Computer system 100 may further include at least one output device 108 such as a display unit, video hardware, or other peripherals (e.g., printer). At least one input device 106 may also be included in computer system 100 that may include a pointing device (e.g., mouse), a text input device (e.g., keyboard), or touch screen.

Communications interfaces 114 also form an important aspect of computer system 100 especially where computer system 100 is deployed as a distributed computer system. Computer interfaces 114 may include LAN network adapters, WAN network adapters, wireless interfaces, Bluetooth interfaces, modems and other networking interfaces as currently available and as may be developed in the future.

Computer system 100 may further include other components 116 that may be generally available components as well as specially developed components for implementation of the present invention. Importantly, computer system 100 incorporates various data buses 116 that are intended to allow for communication of the various components of computer system 100. Data buses 116 include, for example, input/output buses and bus controllers.

Indeed, the present invention is not limited to computer system 100 as known at the time of the invention. Instead, the present invention is intended to be deployed in future computer systems with more advanced technology that can make use of all aspects of the present invention. It is expected that computer technology will continue to advance but one of ordinary skill in the art will be able to take the present disclosure and implement the described teachings on the more advanced computers or other digital devices such as mobile telephones or “smart” televisions as they become available. Moreover, the present invention may be implemented on one or more distributed computers. Still further, the present invention may be implemented in various types of software languages including C, C++, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers.

The present disclosure provides a detailed explanation of the present invention with detailed explanations that allow one of ordinary skill in the art to implement the present invention into a computerized method. Certain of these and other details are not included in the present disclosure so as not to detract from the teachings presented herein but it is understood that one of ordinary skill in the art would be familiar with such details.

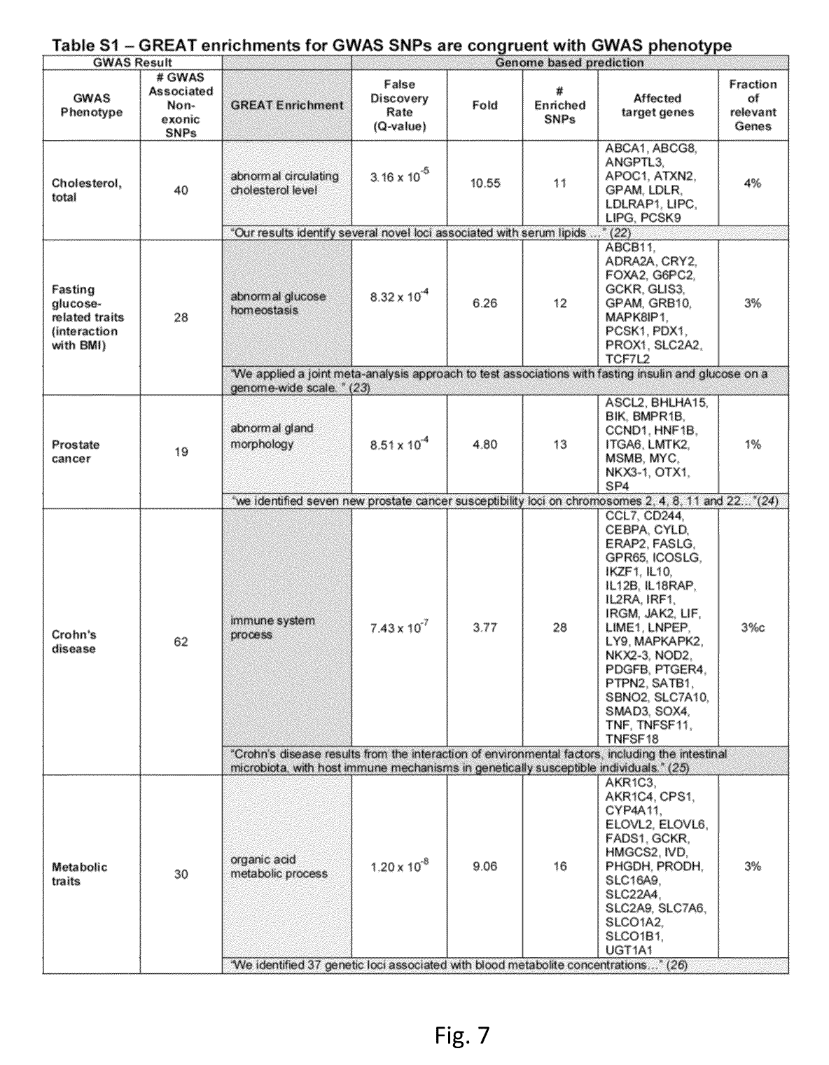

Support for accumulation of small effect variants is suggested when top GWAS significant variants are scored for target gene enrichment and the enrichments reflect the assayed GWAS phenotype (see Table S1 (FIG. 7)). The coherence of target gene enrichment for GWAS variants suggests additive and/or epistatic effects of variations to confer phenotype. Modeling such interactions is generally limited to heuristic search of pairs due to the high computational requirement and lack of statistical power. The statistical power for identifying causal variants is further weakened in non-coding regions due to many neutral variations.

An embodiment of the present invention includes a method that identifies putative functionally relevant variants and then infers their function—in aggregate, on a per individual basis—to side step the need for large computational and statistical power.

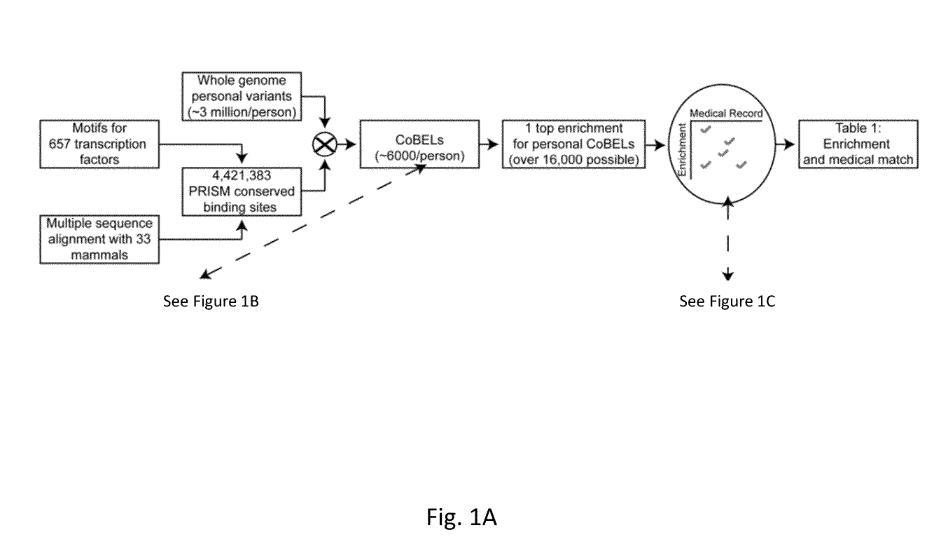

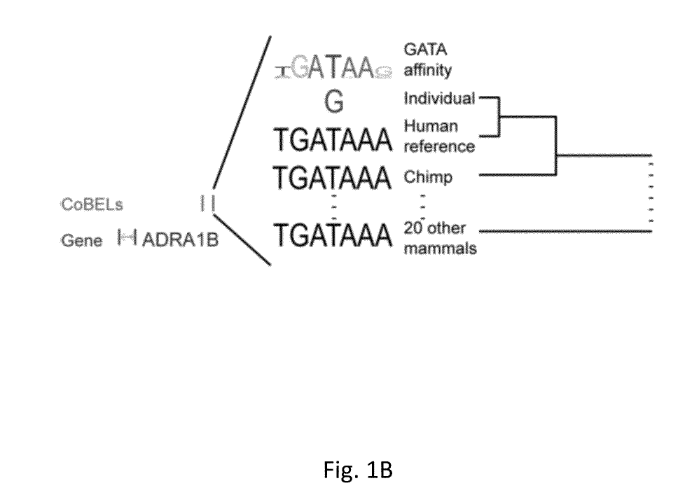

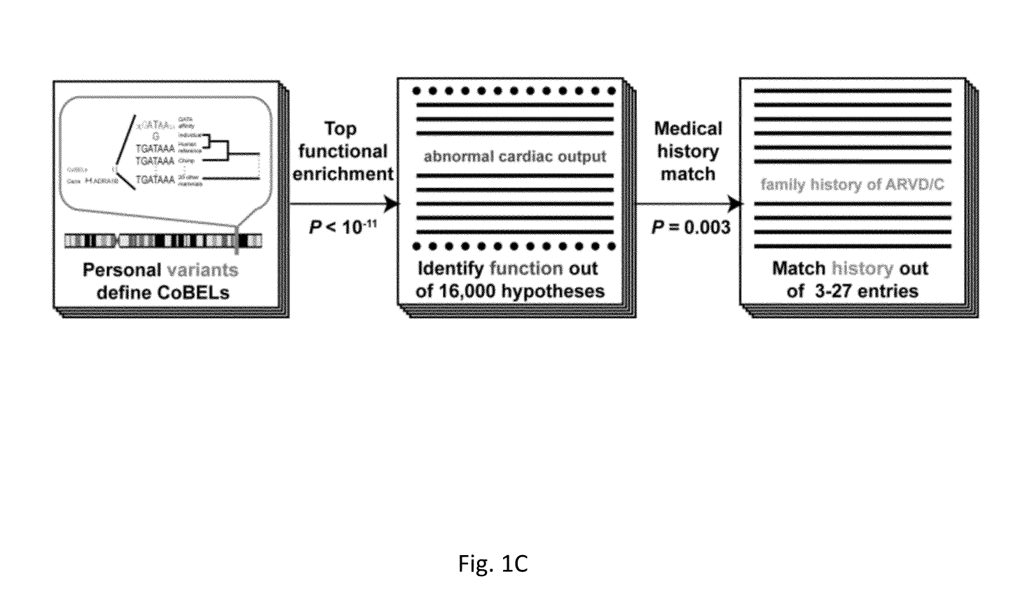

As shown in FIG. 1A for an embodiment of the present invention, using a large library of unique high quality binding motifs for 657 different transcription factors, covering all major human DNA binding domain families and a multiple alignment of 33 primates and mammals, a prediction is made of cross-species conserved binding sites present in the reference human genome (see methods discussion below). In an embodiment as shown in FIG. 1A, 4,421,383 PRISM conserved binding sites were predicted. The genetic variants of a human individual are then examined against the reference genome as shown in FIG. 1A (see Whole genome personal variants). A focus is made on the subset of variants (heterozygous or homozygous) that overlap conserved binding site predictions. From these, a selection is made of only variants where the human reference base is identical to its chimpanzee orthologous base (and thus most likely ancestral), and the individual variant base differs from both. Finally, of these, only the binding sites where the individual (derived) variant is predicted to decrease binding affinity compared to the ancestral base is selected. These are called, in an embodiment of the present invention, conserved binding site eroding loci, or CoBELs (see FIG. 1A-B and methods discussion below).

FIG. 1D is a block diagram of an alternative embodiment of the present invention that highlights a general algorithm 150. To be presented here is a description of each module according to embodiments of the present invention.

Functional Annotation for Base: Step 152

This step assigns bases in the genome functional properties. In an embodiment of the present invention, transcription factor binding sites are assigned based on experimentally defined DNA motif preferences of DNA binding proteins called transcription factors. A mathematical foundation for the prediction are described in this work: Kel A. E. et al, MATCH: A tool for searching transcription factor binding sites in DNA sequences, Nucleic Acids Res. 2003 Jul. 1; 31(13):3576-9 (attached as Appendix A, which is hereby incorporated by reference in its entirety for all purposes). More generally, step 102 can be any functional annotations of important bases that will disrupt a gene from making its protein.

Sequence Conservation: Step 154

Sequence conservation is determined at step 154. This step determines the conservation of a given base or set of bases in an embodiment of the present invention. Conservation is important since it identifies regions that are found in other species suggesting that they are being preserved by evolutionary pressures due to having functional consequences. In an embodiment of the present invention, a multi-species alignment is used consisting of 33 primates and mammals (see FIG. 1A). Other mathematical functions can also be used to define the regions conservation or evolutionary fitness potential.

Conserved Functional Bases: Step 156

In the general case, step 156 filters the bases annotated for function based on a sequence conservation threshold to only identify functionally relevant bases and to ignore neutral bases. In an embodiment of the present invention, an intelligent combination technique is used describe in this work: Wenger A M et al., PRISM offers a comprehensive genomic approach to transcription factor function prediction, Genome Res. 2013 May; 23(5):889-904. doi: 10.1101/gr.139071.112. Epub 2013 Feb. 4. (attached as Appendix B, which is hereby incorporated by reference in its entirety for all purposes). This technique defines the functional annotation conditioned on the sequence conservation (e.g., conserved transcription factor binding sites only if they significantly conserved compared to their genomic background).

Personal Variants: Step 158

At step 158, the changes an individual carries compared to the reference set of predictions are determined. They can be obtained by whole genome sequencing or more sparse methods such as SNP arrays in different embodiments of the present invention. In an embodiment of the present invention, whole genome sequences have been used to maximize the signal.

Conserved Functional Bases Changed by Personal Variants: Step 160

At step 160, a determination is made as to whether a given person's variants change the conserved functional bases. In an embodiment of the present invention, a calculation is made of whether the personal variant causes the transcription factor binding site to lose its binding affinity. More generally any change can be used as long as it can be tied to a biological explanation.

Associate Changed Bases with Genes and Transfer Gene Functions to Base: Step 162

At step 162, changed bases are associated with genes according to an embodiment of the present invention. Also, gene functions are transferred to bases in an embodiment of the present invention. A problem with identifying genome variants is associating phenotype to genotype. There exists a wealth of knowledge that assigns pathways and phenotypic properties to genes. This knowledge can be transferred to the changed bases and statistical tests can be performed to determine whether particular pathways or phenotypic properties are significantly enriched due to the bases relationship to the gene. In an embodiment of the present invention, a presumption is made that the binding site affinity changes are disrupting gene regulation, and thus if multiple genes with similar pathways or phenotypic properties are mis-regulated, then a detectable phenotype will manifest in the person. An enrichment test used in an embodiment of the present invention has been described in this work: McLean C. Y. et al., GREAT improves functional interpretation of cis-regulatory regions, Nat Biotechnol. 2010 May; 28(5):495-501. doi: 10.1038/nbt.1630. Epub 2010 May 2. (attached as Appendix C, which is hereby incorporated by reference in its entirety for all purposes). Alternatively, the disrupted base can be within the gene itself.

Perform Function Enrichment Test: Step 164

At step 164, a function enrichment test is performed as a statistical test to show that the transferred gene functions are significantly enriched in the changed bases in an embodiment of the present invention. A proper null model needs to be chosen to avoid wrong enrichments. In an embodiment, the following test was used: McLean C. Y. et al., GREAT improves functional interpretation of cis-regulatory regions, Nat Biotechnol. 2010 May; 28(5):495-501. doi: 10.1038/nbt.1630. Epub 2010 May 2. (attached as Appendix C, which is hereby incorporated by reference in its entirety for all purposes). But there are many other viable modifications or alternatives to this test.

Link Functional Enrichment with Phenotype: Step 166

At step 166, functional enrichment is linked with a phenotype so as to provide validation. In an embodiment of the present invention, step 118 is an optional step. Step 166 serves to support that the enriched function has already started manifesting in the individual. Alternatively, if the test is performed very early, it is a potential predictive measure in an embodiment of the present invention.

Predict Genetic Source of Phenotype: Step 168

At step 168, a prediction is made as to the genetic source of a phenotype based on the collected information in an embodiment of the present invention. Since the enriched phenotypes are a result of changed bases, a subset of the genetic causes of a phenotype a person is experiencing (or will experience) can be predicted.

### Discussion of Particular Embodiments

In an embodiment, a download was performed of the UCSC whole genome variant files for four individuals for whom medical history summaries are also available: Stephen Quake, and three individuals from the personal genome project (PGP10). An additional file was obtained for James Lupski. Each was then separately compared to the reference genome to obtain 6,321 CoBELs for Quake, 5,291 for George Church, 5,775 for Misha Angrist, 5,861 for Rosalynn Gill, and 6,447 for Lupski.

Because CoBELs weaken conserved ancestral binding sites, whether an individual's set is found preferentially next to genes encoding any particular function was determined, and if so, whether this function relates to the individual's medical history (see FIG. 1C). GREAT (Genomic Regions Enrichment of Annotations Tool) is an approach devised specifically to assess enriched functions within a set of genomic regions thought to regulate the adjacent genes (see C. Y. McLean et al., GREAT improves functional interpretation of cis-regulatory regions, Nat. Biotechnol. 28, 495-501 (2010)). GREAT associates with each gene in the genome a variable length regulatory domain, bracketed by its two neighboring genes. GREAT also holds a large body of knowledge about gene functions and phenotypes—here over 1.1 million such gene annotations were used (see Methods).

For a given set of CoBELs, GREAT iterates over 16,000 different biological functions and phenotypes, asking whether CoBELs are particularly enriched in the regulatory domains of genes of any particular function. For example, 33 genes in the human genome are annotated for “abnormal cardiac output.” Their GREAT assigned regulatory domains cover 0.45% of the genome. Of the 6,321 Quake CoBELs, 28 (0.45%) are expected in the regulatory domains of these 33 genes by chance, but 57 CoBELs, over twice as many, are in fact observed. To determine statistical significance GREAT computes two statistics for this enrichment, and corrects them for multiple hypothesis testing (see methods discussion).

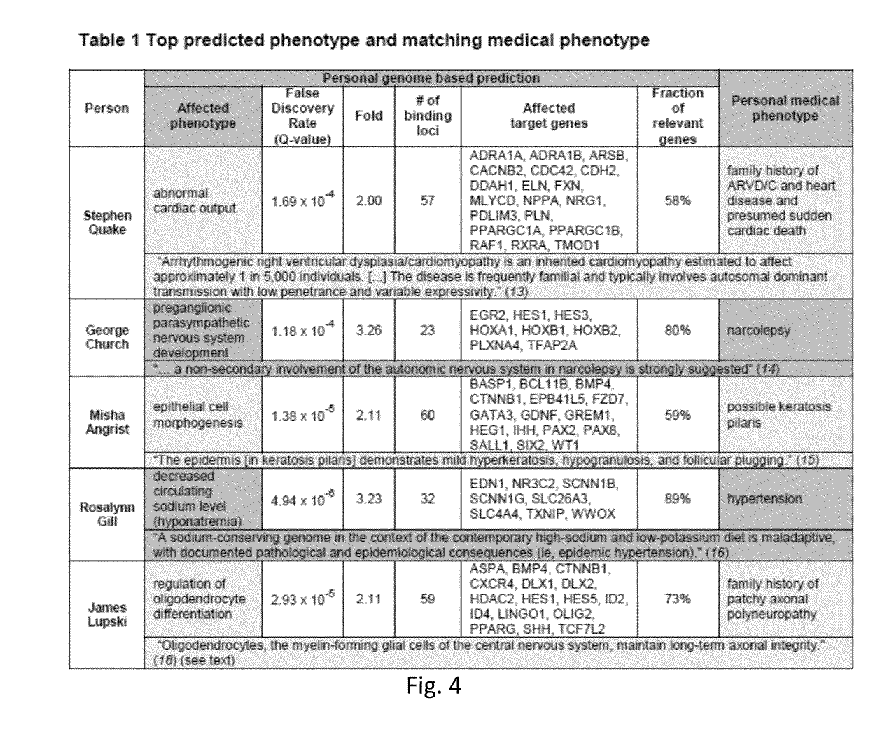

Prominent in Stephen Quake's medical records is a family history of arrythmogenic right ventricular dysplasia/cardiomyopathy, including a possible case of sudden cardiac death. Strikingly, when Quake's set of CoBELs is analyzed using GREAT, the top phenotype enrichment (using default parameter settings, optimized for inference power in the original GREAT paper) is “abnormal cardiac output.” This enrichment is suggestive of susceptibility to heart diseases responsible for reduced cardiac output. Meaningful associations between CoBELs and personal medical records are in fact observed for all five genomes (Table 1 (FIG. 4)):

The top enrichment for George Church, who suffers from narcolepsy, is “preganglionic parasympathetic nervous system development.” The autonomic nervous system is strongly suspected to be involved in narcolepsy. Misha Angrist, whose personal reporting indicates possible keratosis pilaris, a follicular condition manifested by the appearance of rough, slightly red, bumps on the skin, has “epithelial cell morphogenesis” as his top biological process enrichment. For Rosalynn Gill, who suffers from hypertension, the top enriched phenotype is “decreased circulating sodium level.” Sodium intake is strongly associated with hypertension. Intriguingly, the top biological process enrichment obtained for James Lupski, whose family has a history of axonal neuropathies in the peripheral nervous system (PNS), is “regulation of oligodendrocyte differentiation.” Oligodendrocytes are the neuroglia that create the myelin sheath around axons in the central nervous system and maintain long-term axonal integrity (CNS; further discussed below).

In an embodiment, the screen may be underpowered. For example, the binding affinities of all human transcription factors or all functional ancestral binding sites may not be available. Alternatively, variant mapping may miss more complex gene regulatory mutations. Also, binding site, variant, and derived allele calls may all be made against the reference genome, which is not a perfect genome and may mask its own mutational load. Additionally, an embodiment of the present invention, focuses on the top enrichment obtained rather than all enrichments to maintain the ability to test for statistical rigor of the associations. These limitations, however, may only reduce the power to detect true associations, but do not elevate the likelihood of false predictions. In contrast, by focusing on deeply conserved binding sites, the likelihood that their disruption carries a fitness cost is greatly increased. Indeed, considering that GREAT tests over 16,000 different biological processes or phenotypes (from “abdominal aorta aneurysm” to “zymogen granule exocytosis”), the links obtained between genomic prediction and medical phenotype seem highly significant.

To further assess the significance of the results in an embodiment of the present invention, every CoBEL was replaced with a random binding site prediction for the same upstream factor of same affinity and similar cross species conservation. Using 10,000 random control sets, the likelihood of obtaining the functions reported in Table 1 (FIG. 4) as top prediction is very low (Quake P=3×10-4, Church P=5.7×10-3, Angrist P=4.8×10-3, Gill P=1×10-4, Lupski P=1.9×10-3, and combined P=1.6×10-15). Significance remains high when the requirement to recover each exact same term with matching any one of a broader group of 12-60 related functions as top prediction is relaxed (Quake 1.1×10-3, Church P=1.3×10-2, Angrist P=7.7×10-3, Gill P=7.4×10-3, Lupski P=6.5×10-3, and combined P=5.2×10-12; see Methods).

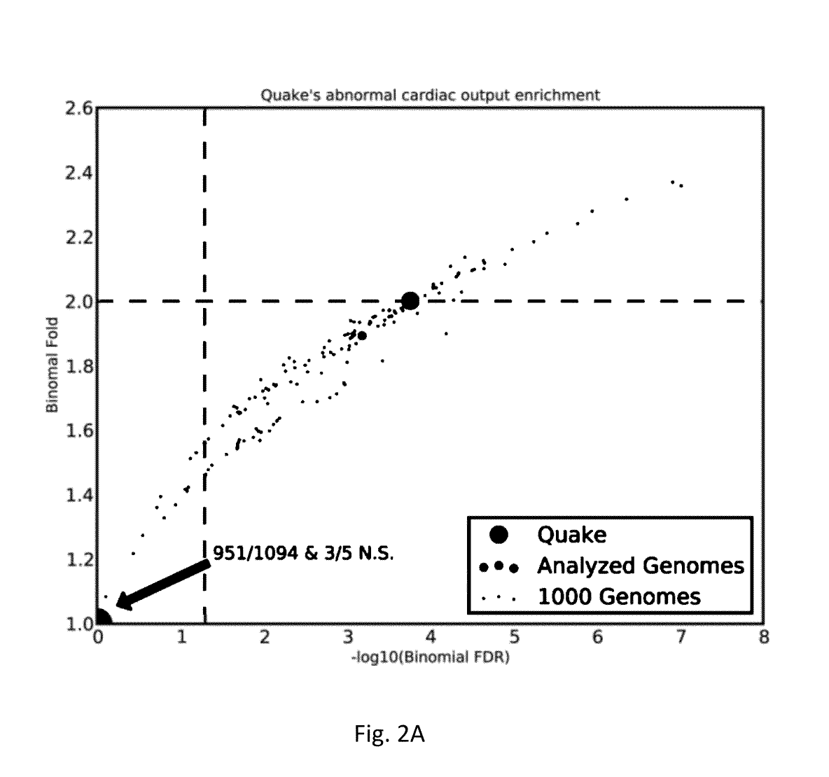

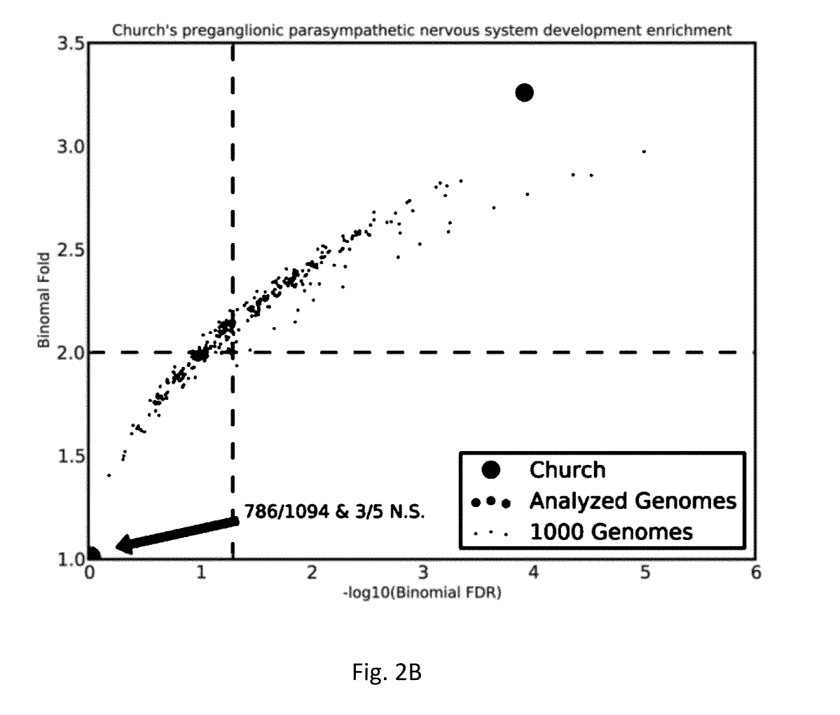

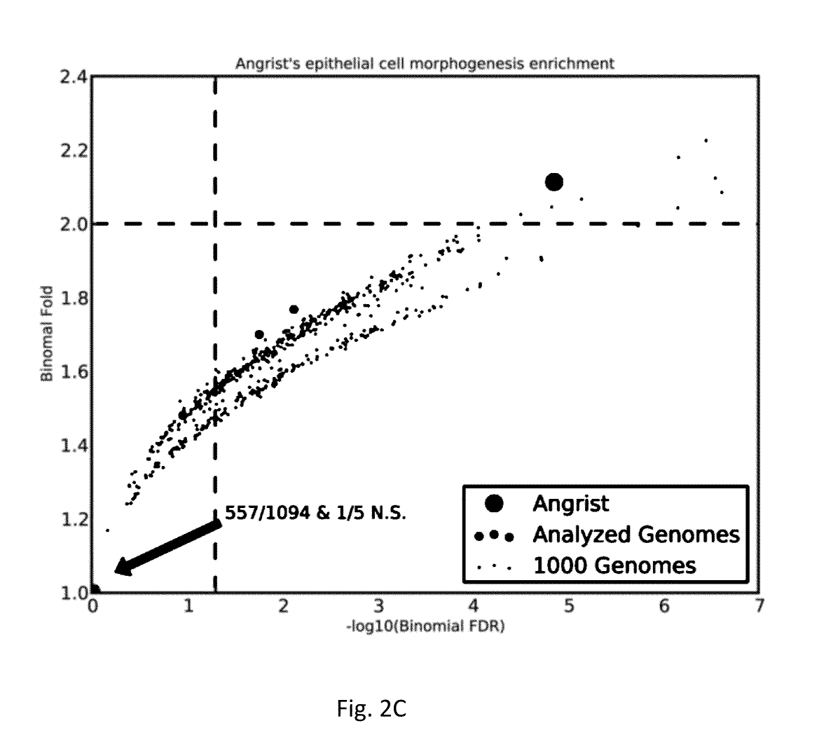

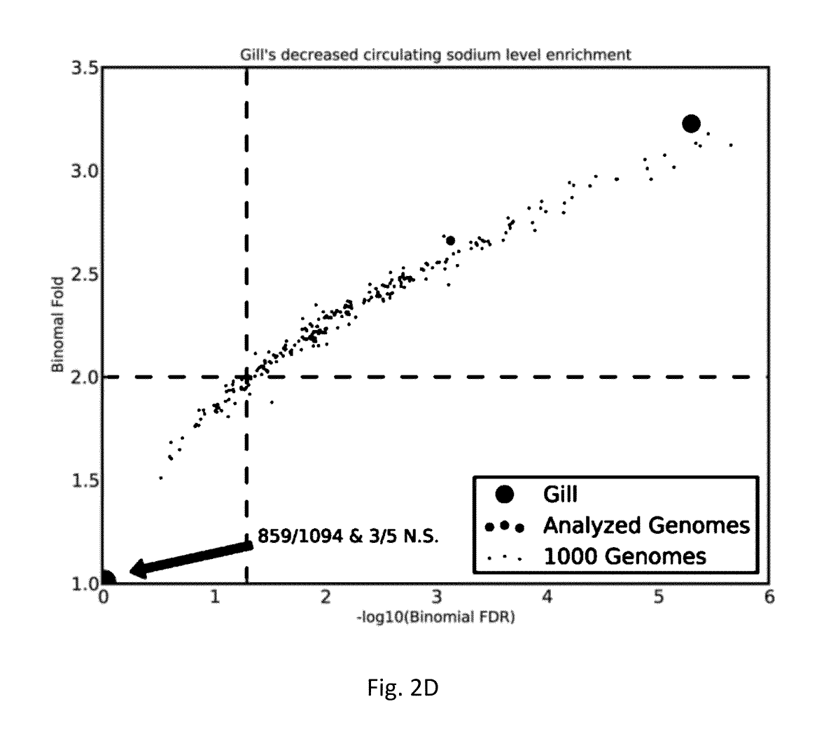

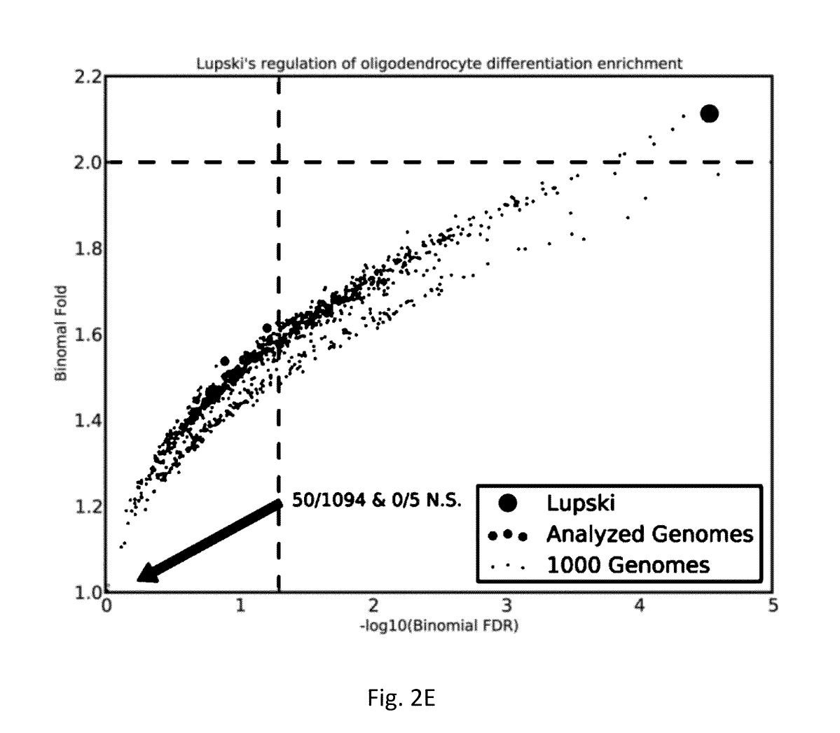

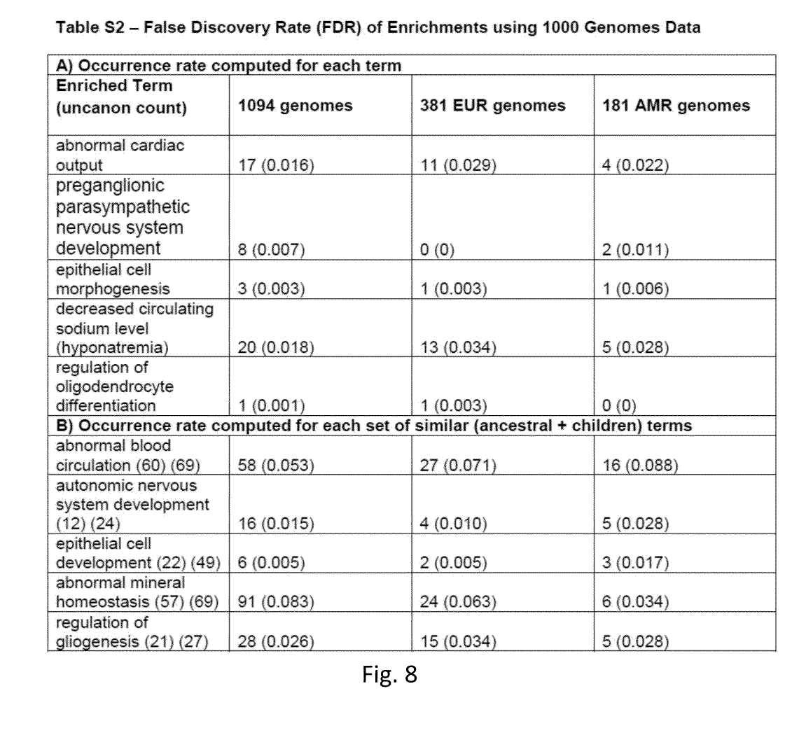

Additionally in an embodiment of the present invention, the frequency of the observed enrichments, in all 1,094 genomes sequenced by the 1000 genomes project was computed. CoBELs for each of 1,094 genomes were submitted to GREAT and the top enrichments were noted. Each one of the observed enrichments had an occurrence rate <0.05 (See Table S2A (FIG. 8)) and the enrichment's p-value and fold statistics placed them at the significantly removed from the 1000 genomes cohort (see FIG. 2).

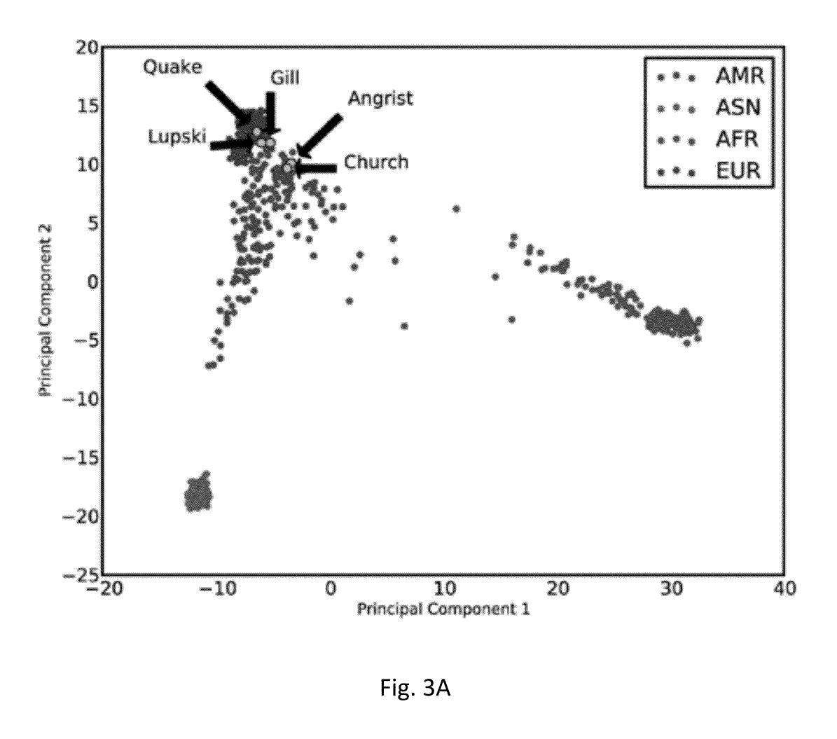

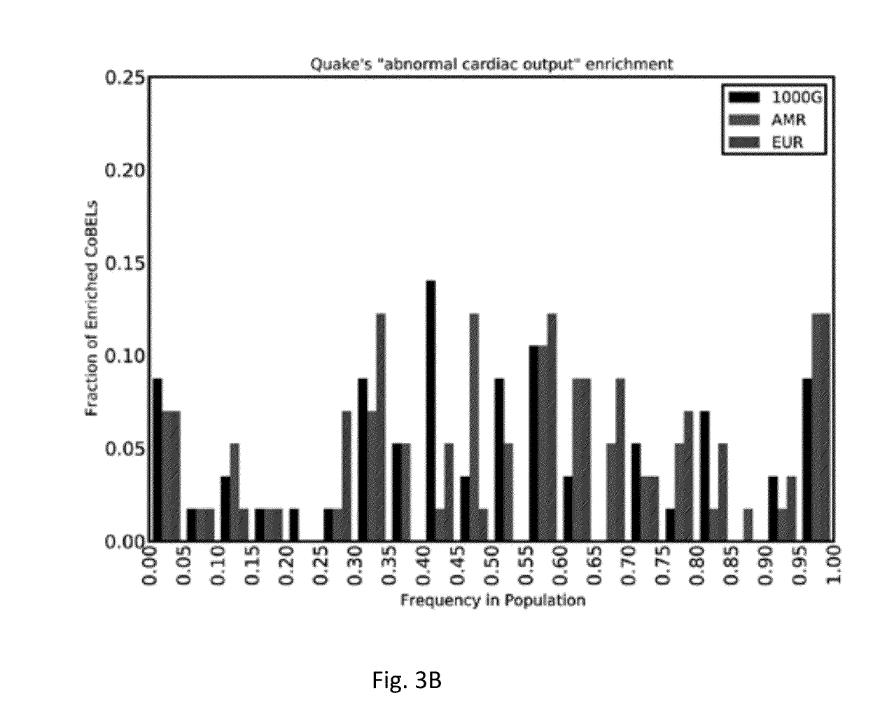

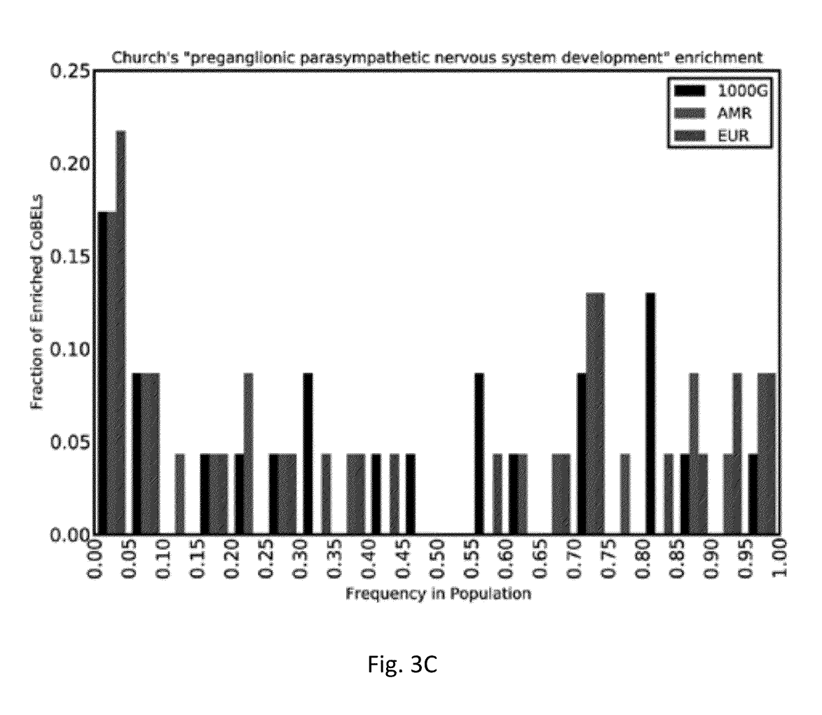

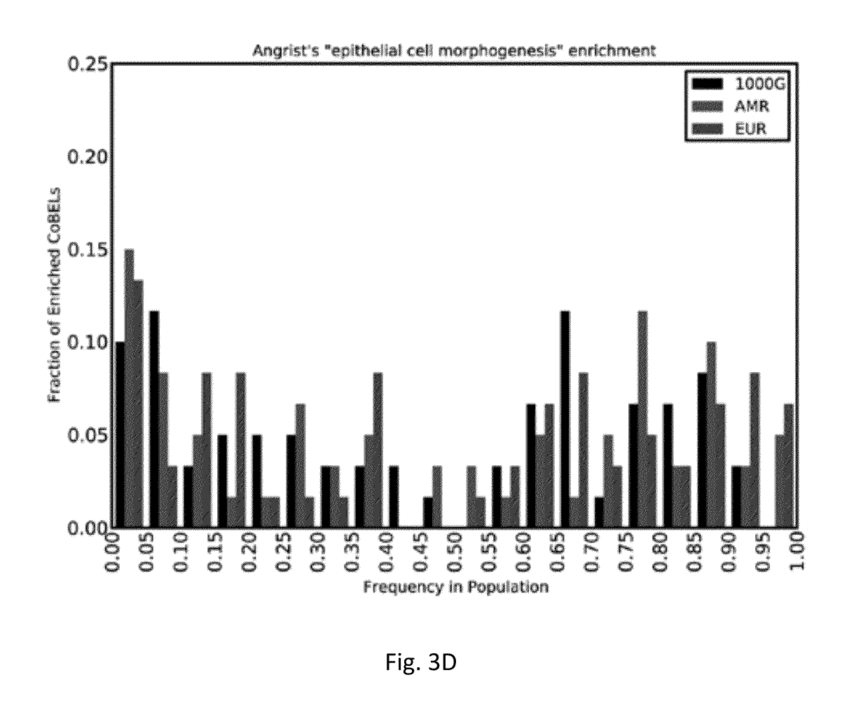

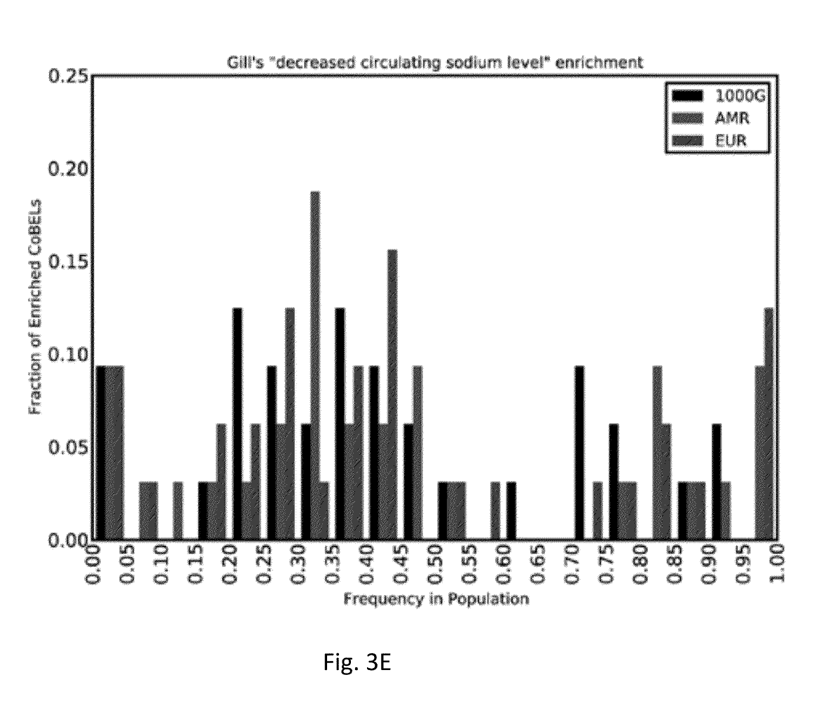

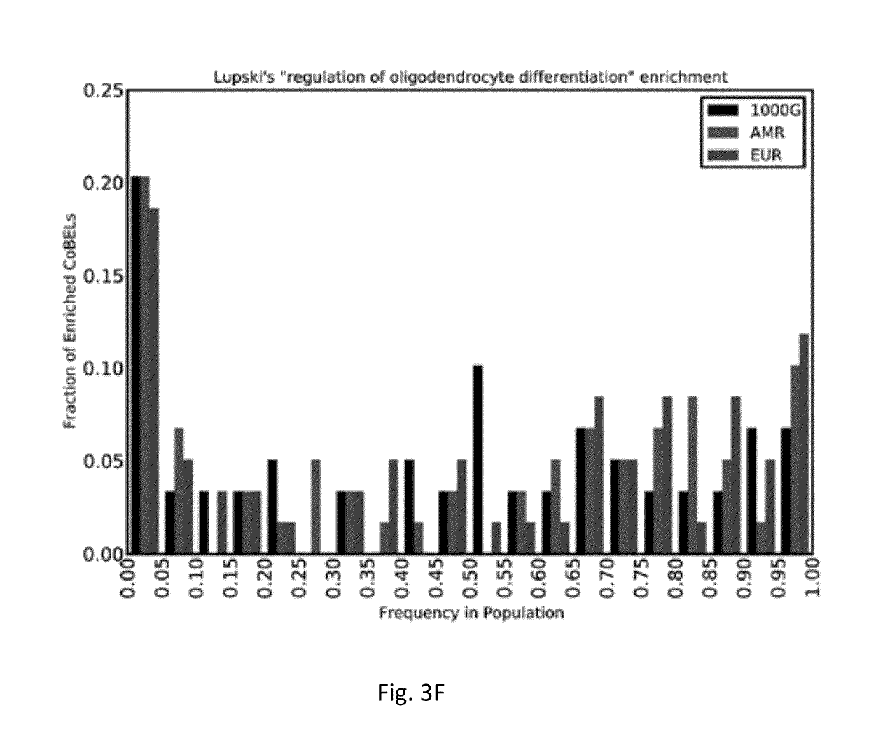

Next, PCA was performed in an embodiment of the present invention to confirm the prior that that the 5 genomes analyzed in this study are predominately European in ancestry (see FIG. 3A) and computed the occurrence rate for the enrichments using only the 381 European genomes and only the 181 admixed genomes to correct for any population specific enrichments. Again all the enriched terms had an occurrence rate <0.05. The occurrence rate for the findings remained less than 0.05 (see Table S2B (FIG. 8)), when both the full 1,092 genomes, 381 European genomes and 181 admixed genomes calculations were repeated for the broader group of related functions, except for those linked to the more common heart and hypertension disorders.

Finally in an embodiment of the present invention, the significance of associating the CoBEL enrichments of five individuals with their medical histories was assessed (see FIG. 1C). Two association matrices were defined linking enrichment and medical history. One matrix was assigned blindly by a medical doctor based on his medical knowledge and another independently by a literature survey. The objective was to compute the chance of associating a set of five individuals with random medical histories with the observed enrichments using one of the two association matrices as the “gold” association. 1,000 sets of five individuals were generated with random medical histories composed of similar disease profiles and assessed the likelihood of being able to associate them with enrichments (see methods discussion). Successfully linking five random individuals with enrichments was highly significant using the association matrix generated by the medical doctor (P=3.0×10-3) and by the matrix generated by literature survey (P=3.0×10-2) suggesting that link between enrichment and medical histories are not just a function of the listed histories. The literature survey derived association matrix potentially offers a stricter null model since it includes associations that are currently research topics hinting at associations that may or may not become clinically relevant in the future.

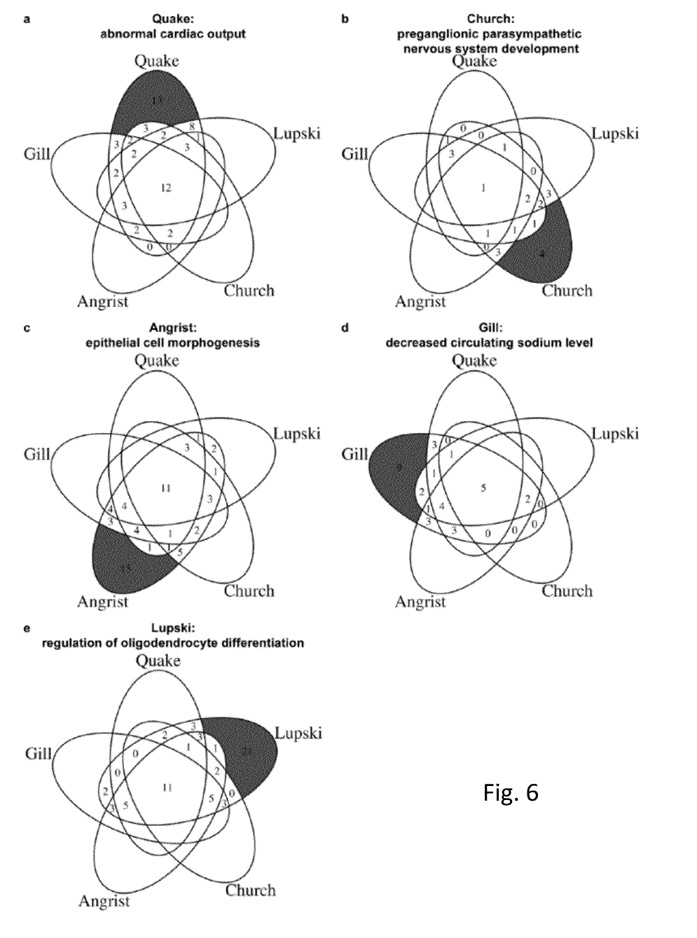

The CoBEL predictions according embodiments of the present invention are distinct from known GWAS associations. The 238 variant alleles that underlie all Table 1 (FIG. 4) predictions overlap a single, context irrelevant, GWAS SNP. When the overlap analysis is extend to include GWAS SNPs in possible linkage disequilibrium (LD), only two possible context matches arise: “cardiac hypertrophy” associated SNP rs3729931 for Quake, and “multiple sclerosis” (another demyelination disease) associated SNP rs882300 for Lupski. Indeed, nearly half the total number of CoBEL variant alleles predicted (7,115, 49%) are unique to only one of the five individuals. Similarly, for each of the five top function predictions in Table 1 (FIG. 4), of sixteen possible subsets (CoBELs shared or not with each of the other four individuals), the biggest contribution (17-34%) always comes from private sites (see FIG. 6). When the CoBEL frequencies are examined at the population level, Quake and Gill's enriched CoBEL's show higher population frequencies (see FIGS. 3B, E) for their presumable more common enriched phenotypes of heart disease and hypertension. Conversely, Church, Lupski and even Angrist to a lesser extent, show more enriched CoBEL with low population frequencies (see FIGS. 3C,D,F).

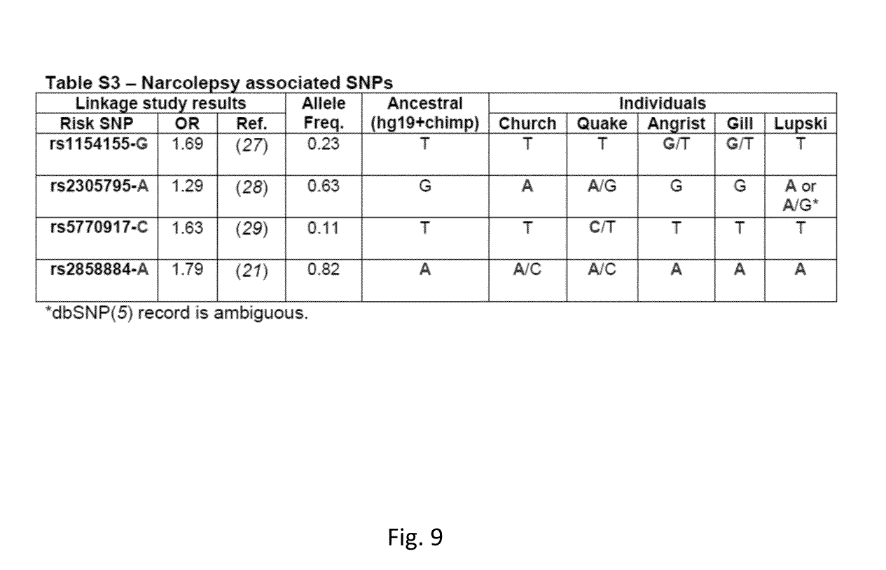

The CoBEL predictions compliment known disease alleles. For example, a particular human leukocyte antigen (HLA) allele is found in a vast majority of narcolepsy patients who suffer from cataplexy, and is also common in narcolepsy patients who do not. The affected Church genome is homozygous for a different HLA allele (see methods discussion). Four GWAS SNPs, all with modest effect size (OR=1.29-1.79) are currently associated with narcolepsy. Church carries two of these, but the other four unaffected genomes that were analyze each carry 2-3 narcolepsy risk alleles as well, due to their common prevalence (see Table S3 (FIG. 9)).

The Quake genome was previously analyzed for coding and GWAS variants. While no single strong mutation emerged, the sum of collected mutations was enough to assess heart disease as a relatively large risk. The evaluation process of the many personal variants, however, was biased towards genic variants and previously determined risk loci with a focus on explaining the family history of heart disease. The enrichment obtained for cardiac output not only comes from novel, non-genic loci, it is also obtained in a completely agnostic fashion.

Two coding mutations in a gene previously implicated in CMT type 4C were found to segregate with CMT type 1 affected individuals in the Lupski family. The strong enrichment obtained is specific to oligodendrocytes (Q=2.93×10-5), which myelinate the CNS. Terms associated with Schwann cells which myelinate the PNS are not enriched (Q=0.45-1). The enrichment according to an embodiment of the present invention may well expose a susceptible genetic background, as the family carries a history of axonal neuropathies that predates the convergence of the two coding mutations.

The accumulation of binding sites in the top enrichments according to an embodiment of the present invention is also revealing: First, each target gene in Table 1 (FIG. 4) is affected, on average, by more than three CoBELs, chipping away at the gene's presumed regulatory robustness. Second, Table 1 (FIG. 4) also shows that in all five cases, CoBELs affect a majority (58-89%) of all human genes annotated for said function/phenotype.

Together, the observations suggest the gradual erosion of gene regulation over both (human generation) time and (gene regulation) space, ultimately manifesting as medical history. These observations corroborate a long held notion that lineage accumulation of small deleterious mutations, even when combined with different lifestyles and environments, ultimately increase the likelihood of familial disease phenotypes. Depending on the selection coefficient of these deleterious mutations and their genetic background, these mutations will eventually be swept out of the population, but are currently visible due to non-natural selection in human breeding and the relatively short timescales since erosion.

The screen according to an embodiment of the present invention provides a view of the latent genetic load of human gene regulation contribution to personal medical histories. As the ability to characterize individual genetic load improves, so will the understanding of the genome—environment interactions, and the thresholds that are crossed to trigger onset of human disease.

Materials and Methods

To be described below are certain further details about materials and methods used in certain embodiments of the present invention. One of ordinary skill in the art will, however, understand that many variations are possible upon an understanding of the present disclosure

Transcription Factor Binding Motif Library

The transcription factor binding motif library of an embodiment of the present invention contains 917 unique high quality monomer and dimer motifs for 657 transcription factors from the UniPROBE (see D. E. Newburger, M. L. Bulyk, UniPROBE: an online database of protein binding microarray data on protein-DNA interactions, Nucleic Acids Res. 37, D77-82 (2009)), JASPAR (see J. C. Bryne et al., JASPAR, the open access database of transcription factor-binding profiles: new content and tools in the 2008 update, Nucleic Acids Res. 36, D102-106 (2008)), and TransFac (see V. Matys et al., TRANSFAC and its module TRANSCompel: transcriptional gene regulation in eukaryotes, Nucleic Acids Res. 34, D108-110 (2006)) databases, secondary UniPROBE motifs, motifs from published ChIP-seq datasets and from other primary literature.

Personal Genomes and Medical History Summaries

Variant calls mapped to the human reference assembly hg19 (GRCh37) were downloaded from the UCSC genome browser. The tables were pgQuake for Stephen Quake, pgChurch for George Church, pgAngrist for Misha Angrist and pgGill for Rosalynn Gill. The variants for James Lupski were downloaded from dbSNP and processed to remove non-single nucleotide polymorphism and those that had ambiguous mapping to the reference genome. The medical history summaries for Stephen Quake and James Lupski were obtained from Ashley et al. (E. A. Ashley et al., Clinical assessment incorporating a personal genome, Lancet 375, 1525-1535 (2010)) and Lupski et al. (J. R. Lupski et al., Whole-genome sequencing in a patient with Charcot-Marie-Tooth neuropathy, N. Engl. J. Med. 362, 1181-1191 (2010)), respectively. Medical history summaries for the remaining individuals were obtained from their public profiles on the Personal Genome Project website.

Identification of Conserved Binding Site Eroding Loci (CoBELs)

Conserved binding sites were identified using the UCSC human reference assembly hg19 (GRCh37) based multiple alignment of 33 primates and mammals in an embodiment of the present invention. Binding site prediction was done by identifying binding site matches in each species, combining them into conserved binding site predictions (minimum of 5 species and branch length of 2 substitutions/site), and keeping only the top 0-5,000 binding site predictions that compare favorably with predictions made from shuffled versions of the motif in similarly conserved regions of the genome (excess conservation P≦0.05). The parameter settings that were used have been previously optimized for predictive power, including against multiple ENCODE (Dunham et al., An integrated encyclopedia of DNA elements in the human genome, Nature 489, 57-74 (2012)) datasets.

Next in an embodiment of the present invention, all the heterozygous or homozygous variants were identified in an individual genome where the human reference (hg19) base is identical to the orthologous chimp (panTro2) base, and thus most likely human ancestral. All human reference genome conserved binding sites affected by the individual specific variants were identified. Of these, only sites where replacing the reference human (ancestral) base(s) with the individual derived variant(s) lowers binding affinity by 5% or more were kept. Overlapping binding sites were combined to obtain the final set of conserved binding site eroding loci (CoBELs).

Inferring Statistically Significant Accumulation of CoBELs Next to Genes that Share a Function or Phenotype

In an embodiment of the present invention, each set of CoBELs was submitted to GREAT (for Genomic Regions Enrichment of Annotations Tool) v2.0.2 using http://great.stanford.edu/ (see Appendix C). As explained above, GREAT searches for statistically significant genomic regions (in this case CoBELs) accumulation in the regulatory domains of genes that share the same annotation. For an embodiment of the present invention, GREAT's default regulatory domain definition were used: a constitutive 5 kb upstream and 1 kb downstream of a gene's canonical transcription start site (TSS), extended up to the constitutive regulatory domain of the adjacent genes on either side, or up to 1 Mb. Significance was also defined using the default GREAT thresholds: 0.05 FDR threshold for both binomial and hypergeometric test and binomial fold greater than 2. These parameter settings have all been adjusted for inference power in the original GREAT paper referenced above. The GO Biological Processes (M. Ashburner et al., Gene ontology: tool for the unification of biology. The Gene Ontology Consortium, Nat. Genet. 25, 25-29 (2000)) and MGI Phenotype (J. A. Blake, C. J. Bult, J. T. Eppig, J. A. Kadin, J. E. Richardson, The Mouse Genome Database genotypes::phenotypes, Nucleic Acids Res. 37, D712-719 (2009)) ontologies were queried allowing GREAT to test for possible enrichment of any of 16,054 different functions, using 1,140,682 gene to function mappings.

Estimating the Significance of Table 1 (FIG. 4) Enrichments Against Shuffles

Generating 10,000 Random Control Sets for Each Individual

In an embodiment of the present invention, each CoBEL is a binding site overlapped by the individual's variants file. In cases of overlapping binding sites, the site that sustained the greatest decrease in binding affinity was chosen. With the binding site mapping, 10,000 random size matched sets were generated by sampling for each CoBEL a random binding site that has an identical binding affinity and a cross species excess conservation p-value within the same order of magnitude as the actual CoBEL.

Defining the Sets of Related Terms

The set of related terms for those reported in Table 1 (FIG. 4) according to an embodiment of the present invention was obtained by using the ontology structure defined by GO Biological Processes (M. Ashburner et al., Gene ontology: tool for the unification of biology. The Gene Ontology Consortium, Nat. Genet. 25, 25-29 (2000)) and MGI Phenotype (J. A. Blake, C. J. Bult, J. T. Eppig, J. A. Kadin, J. E. Richardson, The Mouse Genome Database genotypes::phenotypes, Nucleic Acids Res. 37, D712-719 (2009)). Using the ontology defined relations, more general terms (ancestors) of those in Table 1 (FIG. 4) were used and each set of related terms was defined as one containing the ancestor and all descendant terms (including the term for Table 1 (FIG. 4) and dozens more).

For Quake, a set of 60 related terms was defined as a (null set) match using the ancestor term “abnormal blood circulation.” For Church, a set of 12 related terms was defined using “autonomous nervous system development”, for Angrist, a set of 22 related terms was defined using “epithelial cell development”, for Gill, a set of 57 terms was defined using “abnormal mineral homeostasis” and for Lupski, a set of 21 terms was defined using “regulation of gliogenesis.”

Computing p-Values for Null Hypothesis Tests—Linking CoBELs with Enrichment

In an embodiment of the present invention, the p-value for both null hypothesis tests was computed empirically by counting the number of times the top GREAT enrichment obtained using the random control sets was the same term reported in Table 1 (FIG. 4) (null hypothesis 1) or was in the set of related terms to the term in Table 1 (FIG. 4) (null hypothesis 2).

Computing the Occurrence of Enriched Terms in the 1000 Genomes

In an embodiment of the present invention, the CoBEL methodology was applied to each of the 1094 genomes and the top enrichment satisfying the default GREAT filters in the GO Biological Processes and MGI Phenotype ontologies was tracked. For each of the enrichments highlighted for the five genomes analyzed in this report, the frequency of the enrichment in the full 1094 genomes was computed. Additionally, the frequency of the enrichments in the 381 European (EUR) subset and 181 admixed (AMR) subset was measured since principal component analysis revealed that the five genomes analyzed in this report are closest to these two population subgroups.

Estimating the Significance of Table 1 (FIG. 4) Enrichment-Medical History Associations

Generating 1,000 Sets of Five Individuals with Random Medical Histories

In an embodiment of the present invention, the mapping between each individual and their medical histories was shuffled 1,000 times to creating 1,000 sets of five individuals with random medical histories—to ask the question—if there were five individuals with random medical histories, what is the chance of linking them to the observed CoBEL enrichments. The random individuals were required to have similar number of medical history entries each and for each medical history entry's occurrence frequency to match that observed in the true set. 80% (55/68) of the pairings between individuals and medical histories were also required to be different to avoid creating individuals with medical histories that were too similar to those of the observed individuals.

Defining the Medical History—CoBEL Enrichment Association Matrix

Two independent association matrices were defined to link all observed medical histories and CoBEL enrichments in an embodiment of the present invention. The first matrix was blindly assigned by a medical doctor based on his medical knowledge given that his objective was to infer the possibility of a “medical history” due to mis-regulation of genes involved in “CoBEL enrichment” and/or “CoBEL enrichment” leads to/causes/implicates the organ system of the “medical history.” The second matrix was assigned after an in-depth literature survey.

Computing p-Values for Null Hypothesis Test—Linking Enrichment with Medical History

The p-value was computed empirically by counting the number of times the 1000 random sets of five individuals with random medical histories were by chance associated with an enrichment using a given association matrices according to an embodiment of the present invention.

Enriched CoBELs Overlap or Linkage with GWAS SNPs

All SNPs from the NHGRI GWAS catalog (L. A. Hindorff et al., Potential etiologic and functional implications of genome-wide association loci for human diseases and traits, Proc. Natl. Acad. Sci. U.S.A. 106, 9362-9367 (2009)) were downloaded on Oct., 23 2012 in hg19 (GRCh37) co-ordinates, and intersected with the set of enriched CoBEL variant alleles from Table 1 (FIG. 4). Quake, Angrist, Gill and Lupski had no overlaps. Church had a single, context irrelevant, overlap with rs10808265 which is associated with pulmonary function decline.

To assess linkage disequilibrium (LD) between the enriched CoBEL variants and GWAS SNPs, HapMap re127 LD data was used for the CEU (Utah residents with Northern and Western European ancestry) population. CoBEL variant alleles from Table 1 (FIG. 4) were mapped to HapMap by taking the HapMap provided hg18 (NCBI Build 36.1) co-ordinates, lifting them to hg19 using the UCSC browser liftOver utility and intersecting with the CoBEL variants. Nearly half (49%, 112/227) the enriched variants sites could be mapped to HapMap probes. NHGRI GWAS SNPs were mapped to HapMap SNPs using rsIDs. A GWAS SNP and a CoBEL variant were called in LD, using a maximalist approach, if either D′>0.99 or r2≧0.8 or LOD (log odds)≧2 between their matching HapMap probes.

Church Genome Human Leukocyte Antigen (HLA) Type

Over 90% of narcolepsy patients with cataplexy, and around 40% of narcolepsy patients without cataplexy carry HLA type DQB1*06:02. The crystal structure of HLA-DQB1*06:02 (PDB ID: 1UVQ) identified the representative amino acid haplotype of DQB1*0602 as F₉G₁₃L₂₆Y₃₀Y₃₇A₃₈D₅₇ (subscript represents amino acid number in exon 2 of HLA-DQB1). Based on the variant call file, the haplotype present is George Church is different: Y₉G₁₃L₂₆H₃₀Y₃₇A₃₈D₅₇. When BLAST was used to search the Church version of exon 2 against the IMGT/HLA Database, the allele closest to the observed haplotype was DQB1*06:03, not found associated with narcolepsy patients.

It should be appreciated by those skilled in the art that the specific embodiments disclosed herein may be readily utilized as a basis for modifying or designing other algorithms or systems. It should also be appreciated by those skilled in the art that such modifications do not depart from the scope of the invention as set forth in the appended claims. For example, variations to the methods can include changes that may improve the accuracy or flexibility of the disclosed methods.

What is claimed is:

1. A computer-implemented method for identifying disease variants, comprising:
receiving, by a computer, digitized genetic information comprising genome sequence information for at least one human individual;
receiving, by a computer, digitized functional annotations of predetermined bases that disrupt a gene from making a predetermined protein;
receiving, by a computer, digitized genetic information comprising genome sequence information for a plurality of references;
determining, by a computer, a plurality of conserved functional bases among the plurality of references;
filtering, by a computer, the digitized functional annotations based on a predetermined threshold to substantially identify a plurality of functionally relevant bases;
identifying, by a computer, a plurality of genetic changes for the at least one human individual;
associating, by a computer, a set of the plurality of genetic changes for the at least one human individual that change the conserved functional bases to a gene function;
associating, by a computer, the changed bases with genes;
identifying, by a computer, a set of transferred gene functions that are substantially enriched by the changed bases;
predicting, by a computer, a genetic source of a phenotype based on at least the set of transferred gene functions.

2. The method of claim 1, further comprising linking, by a computer, the set of transferred gene functions to a phenotype.

3. The method of claim 1, wherein the digitized functional annotations of predetermined bases are binding motifs.

4. The method of claim 1, wherein the plurality of conserved functional bases among the plurality of references include mammal information.

5. The method of claim 1, wherein the plurality of conserved functional bases among the plurality of references includes conserved binding sites.

6. The method of claim 1, further comprising transferring gene functions to bases.

7. The method of claim 1, wherein the plurality of references include a plurality of genomic information from mammals.

8. The method of claim 1, wherein the genome sequence information for at least one human individual comprises substantially a whole genome.

9. The method of claim 1, wherein the genome sequence information for at least one human individual comprises substantially less than a whole genome.

10. The method of claim 1, further comprising determining whether conserved functional bases exhibit reduced binding affinity.

11. A non-transitory computer-readable medium including instructions that, when executed by a processing unit, cause the processing unit to identify disease variants, by performing the steps of:
receiving digitized genetic information comprising genome sequence information for at least one human individual;
receiving digitized functional annotations of predetermined bases that disrupt a gene from making a predetermined protein;
receiving digitized genetic information comprising genome sequence information for a plurality of references;
determining a plurality of conserved functional bases among the plurality of references;
filtering the digitized functional annotations based on a predetermined threshold to substantially identify a plurality of functionally relevant bases;
identifying a plurality of genetic changes for the at least one human individual;
associating a set of the plurality of genetic changes for the at least one human individual that change the conserved functional bases to a gene function;
associating the changed bases with genes;
identifying a set of transferred gene functions that are substantially enriched by the changed bases;
predicting a genetic source of a phenotype based on at least the set of transferred gene functions.

12. The non-transitory computer-readable medium of claim 11, further comprising linking, by a computer, the set of transferred gene functions to a phenotype.

13. The non-transitory computer-readable medium of claim 11, wherein the digitized functional annotations of predetermined bases are binding motifs.

14. The non-transitory computer-readable medium of claim 11, wherein the plurality of conserved functional bases among the plurality of references include mammal information.

15. The non-transitory computer-readable medium of claim 11, wherein the plurality of conserved functional bases among the plurality of references includes conserved binding sites.

16. The non-transitory computer-readable medium of claim 11, further comprising transferring gene functions to bases.

17. The non-transitory computer-readable medium of claim 11, wherein the plurality of references include a plurality of genomic information from mammals.

18. The non-transitory computer-readable medium of claim 11, wherein the genome sequence information for at least one human individual comprises substantially a whole genome.

19. The non-transitory computer-readable medium of claim 11, wherein the genome sequence information for at least one human individual comprises substantially less than a whole genome.

20. The non-transitory computer-readable medium of claim 11, further comprising determining whether conserved functional bases exhibit reduced binding affinity.

21. A computing device comprising:
a data bus;
a memory unit coupled to the data bus;
a processing unit coupled to the data bus and configured to
receive, by a computer, digitized genetic information comprising genome sequence information for at least one human individual;
receive, by a computer, digitized functional annotations of predetermined bases that disrupt a gene from making a predetermined protein;
receive, by a computer, digitized genetic information comprising genome sequence information for a plurality of references;
determine, by a computer, a plurality of conserved functional bases among the plurality of references;
filter, by a computer, the digitized functional annotations based on a predetermined threshold to substantially identify a plurality of functionally relevant bases;
identify, by a computer, a plurality of genetic changes for the at least one human individual;
associate, by a computer, a set of the plurality of genetic changes for the at least one human individual that change the conserved functional bases to a gene function;
associate, by a computer, the changed bases with genes;
identify, by a computer, a set of transferred gene functions that are substantially enriched by the changed bases;
predict, by a computer, a genetic source of a phenotype based on at least the set of transferred gene functions.
